(19) United States
(12) Patent Application Publication
(10) Pub. No.: US 2011/0151780 A1
(43) Pub. Date: Jun. 23, 2011

(54) System and Method for Integration of an Antenna in an Information Handling System Housing

(76) Inventors: Charles D. Hood, III, Cedar Park, TX (US); James W. Clardy, Austin, TX (US); Matt McGowan, Austin, TX (US); Timothy Milam, Round Rock, TX (US)

(21) Appl. No.: 12/641,415

(22) Filed: Dec. 18, 2009

(51) Int. Cl. H04B 5/00; H04N 5/44; H01Q 1/42

(52) U.S. Cl. 455/41.1; 348/725; 343/872

(57) ABSTRACT

An information handling system having an antenna disposed at an outer housing surface provides wireless information signals received by the antenna to a receiver within the housing by capacitive coupling of the signals through the housing. A capacitive pattern portion connected to the antenna at the outer housing surface is disposed opposite a capacitive coupler at the inner surface so that electromagnetic energy of wireless signals inductively couples between the conductive material of the capacitive pattern portion and the capacitive coupler through non-conductive material of the housing without physical contact between the capacitive pattern portion and the capacitive coupler.

### BACKGROUND OF THE INVENTION

1. Field of the Invention

The present invention relates in general to the field of information handling system wireless communication, and more particularly to a system and method for integration of an antenna in an information handling system housing.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Improvements in processing capability of components used to build information handling systems have supported greater processing capability in smaller housings. One result of this is a trend for end users to purchase portable information handling systems as replacements for desktop information handling systems. Portable information handling systems typically have an integrated keyboard, display and power source so that the system operates free from any fixed assets, such as peripheral devices or electrical outlet power sources. End users have migrated to portable information handling systems because of the convenience of using a system “on the go.” One additional feature that has contributed to the adoption of portable information handling systems by end users is the ability for the portable systems to communicate through wireless networks, such as wireless local area networks (WLANs) configured according to IEEE 802.11(g). End users have learned to look for “hot spots” that allow Internet access through a WLAN and thus allow the end user to communicate with work or home network resources. Other types of wireless communication resources are sometimes included that further enhance the convenience of portable systems. For example, access through cellular telephone wireless wide area networks (WWANs) allow end users Internet access over a wider area without reliance on hot spots. More recently, portable information handling systems have included television antenna resources that allow a portable system to receive and display television shows received through television station transmissions.

One difficulty with supporting wireless communication at a portable information handling system is including antenna structures to transmit and receive the wireless communications. An antenna structure competes for space within a portable housing that has limited space. Integration of a television antenna presents a substantial problem because of the low frequency transmissions involved and the corresponding large antenna structure needed for such low frequencies. In some instances, integration of an antenna structure leads to increased housing size, which increases the size, weight and cost of the information handling system. One method for integrating an antenna in an information handling system is to insert-mold the antenna structure into the housing. For example, a printed film having an antenna material and structure is insert-molded into plastic parts that cover the housing for decorative purposes in a process generally known as In-Mold Decoration (IMD). A patterned metallic film on the non-cosmetic side of the film is shaped for an antenna addressed to a desired frequency.

One difficulty with IMD antenna structures is connecting the antenna to the transceiver located within the information handling system housing. A coaxial cable typically interfaces the transceiver and antenna, however, a coaxial cable cannot route directly with an IMD antenna structure without a negative impact on the cosmetic appearance of the information handling system. One method used to interface a cable with an IMD antenna structure is to use an insert molded metal contact that touches the metal film of the IMD structure. However, this method provides an unreliable connection in production and introduces defects to the cosmetic surface.

### SUMMARY OF THE INVENTION

Therefore a need has arisen for a system and method which interfaces a cable and an antenna structure of an information handling system.

In accordance with the present invention, a system and method are provided which substantially reduce the disadvantages and problems associated with previous methods and systems for interfacing a cable and an antenna structure of an information handling system. An antenna at the outer surface of an information handling system housing communicates with a transceiver disposed in the housing through capacitive coupling. Opposing conductive portions on the inner and outer surface of the housing communicate wireless signal energy without a physical conductive connection between the portions.

More specifically, an information handling system is built from plural processing components disposed within a housing. For example, a CPU, RAM, hard disk drive, chipset and transceiver disposed within a chassis portion of the housing cooperate to generate visual information for presentation at a display disposed within a lid portion of the housing. An antenna disposed the outer surface of the housing, such as in a film placed over the lid, receives wireless signal transmissions, such as High Definition television signals, and conducts the wireless signal transmissions to a capacitive pattern portion connected to the antenna. The capacitive pattern portion is disposed at the housing outer surface opposing a capacitive coupler disposed at the housing inner surface so that wireless signal energy inductively couples between the conductive material of the capacitive pattern portion and the capacitive coupler. A cable connected to the capacitive coupler provides the wireless signal energy to the transceiver so that the wireless signal is available at the information handling system, such as to present visual images of a television signal.

The present invention provides a number of important technical advantages. One example of an important technical advantage is that an antenna structure and cable communicate through a housing material without a physical connection by using capacitive coupling. By avoiding the need for a physical connection between an antenna and cable, the antenna integrates with cosmetic surfaces of the information handling system housing without degrading the appearance of the cosmetic surface. Further, production of information handling systems is simplified since a physical connection does not have to be made and tested during manufacture of the information handling system. Integration of an antenna in a cosmetic surface of a portable information handling system lid provides excellent exposure of the antenna structure for improved reception and transmission with a reduced cost of production.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having an antenna capacitively coupled to a receiver through a non-conducting housing material;

FIG. 2 depicts a side view of an information handling system housing having an antenna at the housing outer surface capacitively coupled to a cable at the housing inner surface; and

FIG. 3 depicts an example layout of antennae disposed at an information handling system housing outer surface.

### DETAILED DESCRIPTION

Capacitively coupling an antenna at an outer surface of an information handling system with a receiver disposed within the information handling system allows reception of wireless signals without a physical connection between the receiver and the antenna. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

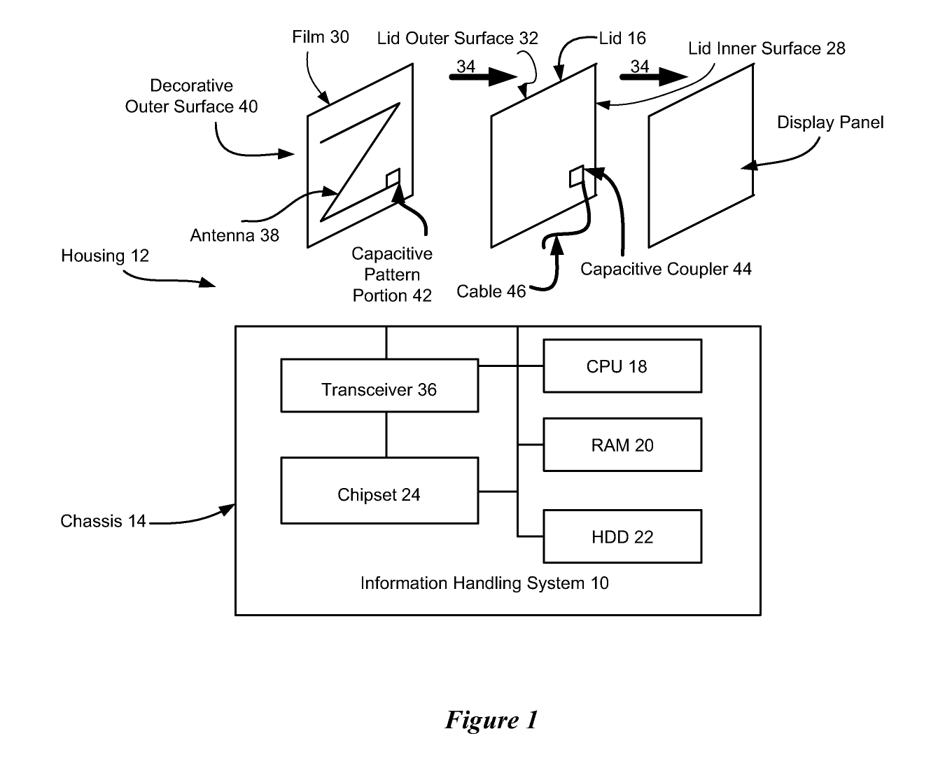

Referring now to FIG. 1, a block diagram depicts an information handling system 10 having an antenna capacitively coupled to a receiver through a non-conducting housing material. Information handling system 10 is built with plural processing components disposed within a housing 12. For example, information handling system 10 is a portable system with housing 12 built from a chassis 14 having a rotationally coupled lid 16 that opens and closes in a clamshell configuration. Chassis 14 has processing components disposed within its interior, such as a CPU 18, RAM 20, a hard disk drive 22 and a chipset 24. Lid 16 supports a display panel 26 on an inner surface 28 and has a decorative film 30 on its outer surface 32. As depicted in FIG. 1, lid 16 is a blow up view with arrows 34 indicating that display panel 26 assembles to lid inner surface 28 and film 30 assembles to lid outer surface 32. The processing components within chassis 14 cooperate to process information for presentation by display panel 26. For example, instructions running on CPU 18 generate visual information which chipset 24 provides to display panel 26 for presentation as images.

Information handling system 10 has a transceiver 36 which transmits and receives information using wireless signals. For example, transceiver 36 supports wireless communication through a wireless local area network or a wireless wide area network by transmitting and sending wireless signals. In one embodiment, transceiver 36 has only a receiver that receives wireless signals without a transmitter to transmit wireless signals. As an example, transceiver 36 includes a receiver that receives television signals, such as High Definition television signals transmitted from television stations. The television signals are processed by the processing components, such chipset 24 and CPU 18 using RAM 20, and presented at display panel 26 as visual images. In order to receive or transmit wireless signals, transceiver 36 uses an antenna 38 that is sized and tuned to handle wireless signals having the frequency of interest. For instance, television wireless signals have a relatively low frequency that calls for a relatively large length. To obtain an appropriate length in an area that can access wireless signals, antenna 38 is integrated with film 30 across surface area of lid outer surface 32. Antenna 38 is optionally built on the inside surface of film 30 so that antenna 32 will not be visible to an end user once film 30 is assembled over lid outer surface 32 to expose decorative outer surface 40.

Antenna 38 interfaces with transceiver 36 with capacitive coupling in which wireless signal energy inductively couples to opposing conductive structures located on outer surface 32 and inner surface 28 of lid 16. A capacitive pattern portion 42 physically connects with antenna 38 on lid outer surface 32, such as by incorporating the structure with antenna 38 during manufacture of film 30. A capacitive coupler 44 physically connects with a cable 46, such as a coaxial cable, which in turn physically connects with transceiver 36 so that wireless signal energy received at capacitive coupler 44 is communicated to transceiver 36 within housing 12. When film 30, lid 16 and display panel 26 are assembled, capacitive pattern portion 42 aligns with capacitive coupler 44 with lid 16 disposed between them so that capacitive pattern portion 42 and capacitive coupler 44 do not touch each other. Wireless signal energy picked up by antenna 38 is communicated to capacitive pattern portion 42 by the connection between antenna 38 and capacitive pattern portion 42, and then communicated to capacitive coupler 44 with inductive coupling. Wireless signal energy transmitted by transceiver 36 is communicated through cable 46 to capacitive coupler 44 and then communicated to capacitive pattern portion 42 with inductive coupling for transmission from antenna 38.

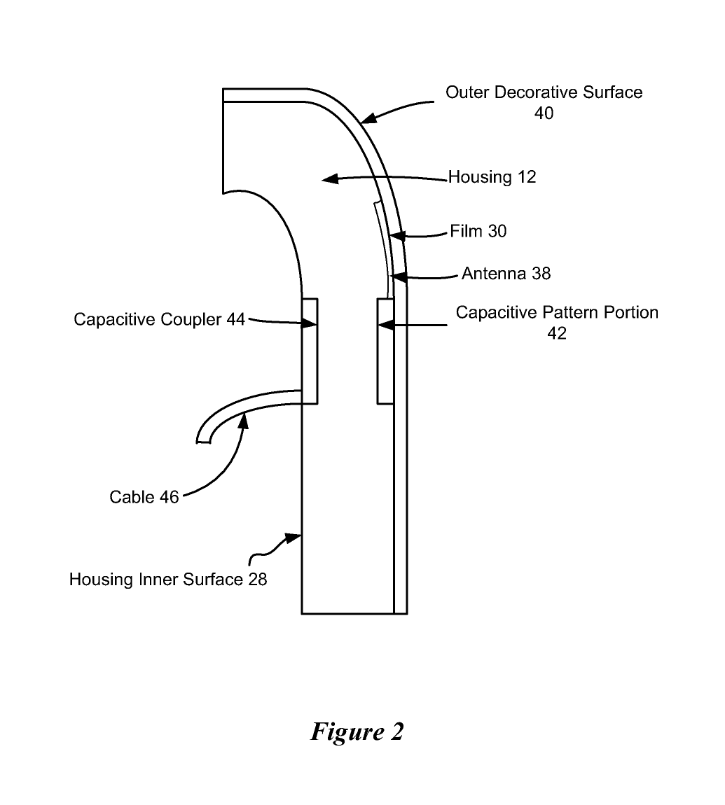

Referring now to FIG. 2, a side view depicts an information handling system housing 12 having an antenna at the housing outer surface 40 capacitively coupled to a cable 46 at the housing inner surface 28. Housing 12 is made of a non-conductive material, such as plastic, that does not interfere with transmission of wireless signal energy between capacitive pattern portion 42 and capacitive coupler 44. Capacitive pattern portion 42 and capacitive coupler 44 are made of conductive materials, such as silver conductive epoxy, aluminum, gold, copper or silver. Film 30 is, for instance, an in mold decorative film having a cosmetic decoration exposed at outer decorative surface 40 and an antenna incorporated along the surface proximate to housing 12. Capacitive coupler 44 and capacitive pattern portion 42 are of a proximity that supports inductive communication of wireless signals between each other so that no direct conductive connection is needed to communicate wireless signal energy.

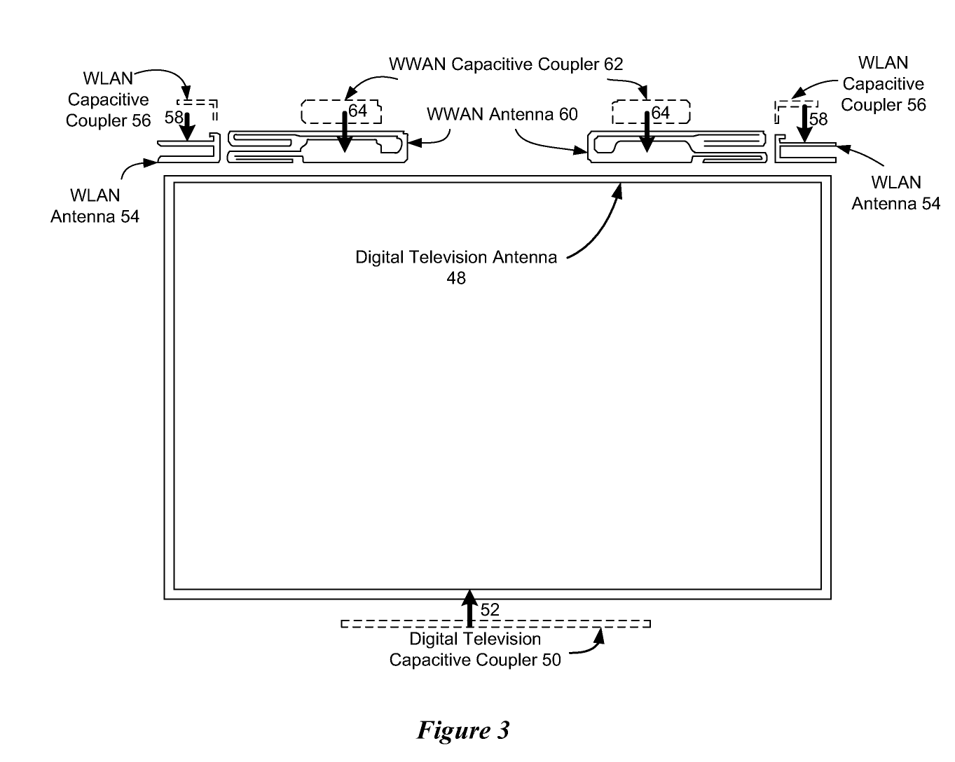

Referring now to FIG. 3, an example layout is depicted antennae disposed at an information handling system housing outer surface. A digital television antenna 48 is disposed in a decorative outer surface and has a rectangular configuration that extends along the outer circumference of the information handling system housing. A digital television capacitive coupler 50 disposed in the housing is aligned over a portion of antenna 48 as indicated by alignment arrow 52 to capacitively couple with digital television antenna 48. Wireless local area network antennae 54 are disposed in a decorative outer surface and has a U shape configuration. Wireless local area network capacitive couplers 56 disposed in the housing each have an L shape configuration that aligns over a portion of WLAN antennae 54 as indicated by alignment arrow 58. Wireless wide area network antennae 60 have a meander line and slot configuration disposed in a decorative outer surface. Wireless wide area network capacitive couplers 62 have a substantially rectangular configuration disposed in the housing and aligned with antennae 60 as indicated by alignment arrow 64. Each of antennae 48, 54 and 60 pass signals between the decorative outer surface and the information handling system housing with their respective capacitive coupler 50, 56 and 62 so that a physical wired connection between each antennae and internal housing wiring is not required.

Although the present invention has been described in detail, it should be understood that various changes, substitutions and alterations can be made hereto without departing from the spirit and scope of the invention as defined by the appended claims.

What is claimed is:

1. An information handling system comprising:
a housing made of a housing material and having an interior surface and an exterior surface;
plural processing components disposed in the housing and operable to cooperate to process information;
a receiver interfaced with the processing components, the receiver operable to wirelessly communicate information;
an antenna disposed at the outer surface of the housing, the antenna having a capacitive pattern portion; and
a capacitive coupler interfaced with the receiver and disposed at the inner surface of the housing proximate the antenna capacitive pattern portion, the capacitive coupler operable to communicate the wireless information with the capacitive pattern portion through the housing material.

2. The information handling system of claim 1 wherein the housing material comprises a non-conducting material.

3. The information handling system of claim 2 wherein the housing material comprises plastic.

4. The information handling system of claim 1 wherein the housing comprises a chassis and a lid rotationally coupled to the chassis and wherein the antenna is disposed in a film disposed over an outer surface of the lid.

5. The information handling system of claim 4 wherein the antenna comprises an in-mold decoration.

6. The information handling system of claim 1 further comprising a coaxial cable disposed in the housing and coupled to the receiver and the capacitive coupler to communicate the information between the receiver and the antenna.

7. The information handling system of claim 1 wherein the capacitive coupler and the capacitive pattern portion comprise opposing metallic films disposed on opposite surfaces of the housing so as not to touch each other.

8. The information handling system of claim 7 wherein the metallic films comprise copper.

9. The information handling system of claim 7 wherein the opposing metallic films comprise silver epoxy.

10. A method for interfacing a receiver disposed in an information handling system housing with an antenna disposed at the outer surface of the housing, the method comprising:
disposing a capacitive pattern portion at the outer surface of the housing in physical communication with the antenna;
disposing a capacitive coupler at the inner surface of the housing proximate to but not touching the capacitive pattern portion, the capacitive couple in communication with the receiver; and
communicating wireless information signals between the capacitive coupler and the capacitive pattern portion.

11. The method of claim 10 wherein the wireless information signals comprise television signals, the method further comprising presenting the television signals as visual images at a display of the information handling system.

12. The method of claim 10 wherein the wireless information signals comprise wireless local area network signals.

13. The method of claim 10 wherein the wireless information signals comprise wireless wide area network signals.

14. The method of claim 10 wherein the capacitive pattern portion comprises a metallic film integrated with the antenna.

15. The method of claim 10 wherein the antenna comprises an in-mold decoration film.

16. The method of claim 10 wherein the capacitive coupler comprises a sheet of conductive metallic material.

17. The method of claim 10 wherein the housing comprises a non-conductive material disposed between the capacitive pattern portion and the capacitive coupler.

18. A system for interfacing an antenna and a wireless receiver, the system comprising:
a housing;
a film disposed on an outer surface of the housing, the film integrated with the antenna;
a capacitive pattern portion disposed on the outer surface of the housing and in physical communication with the antenna; and
a capacitive coupler disposed on an inner surface of the housing and in physical communication with the receiver, the capacitive coupler receiving signals from the capacitive pattern portion and providing the signals to the receiver.

19. The system of claim 18 wherein the receiver comprises a television receiver.

20. The system of claim 18 further comprising plural antennae, each antenna associated with a wireless receiver and in physical communication with the capacitive pattern portion.
